(19) United States
(12) Patent Application Publication
(10) Pub. No.: US 2023/0389111 A1
(43) Pub. Date: Nov. 30, 2023

(54) METHOD AND APPARATUS TO OPTIMIZE RANDOM ACCESS IN WIRELESS COMMUNICATION SYSTEM

(71) Applicant: Samsung Electronics Co., Ltd., Gyeonggi-do (KR)

(72) Inventors: Sangbum KIM, Gyeonggi-do (KR); Anil AGIWAL, Gyeonggi-do (KR)

(21) Appl. No.: 18/322,036

(22) Filed: May 23, 2023

(30) Foreign Application Priority Data
May 24, 2022 (KR) 10-2022-0063302

(51) Int. Cl. H04W 76/20; H04W 76/30; H04B 17/318

(52) U.S. Cl. CPC H04W 76/20; H04W 76/30; H04B 17/328

(57) ABSTRACT

The disclosure relates to a fifth generation (5G) or sixth generation (6G) communication system for supporting a higher data transmission rate. More specifically, the disclosure relates to a method performed by a user equipment (UE) in a wireless communication system, including receiving, from a base station, a radio resource control (RRC) release message including first information for a small data transmission (SDT) configuration, transmitting, to the base station, small data based on the first information, and transmitting, to the base station, a random access (RA) report including SDT information.

### CROSS-REFERENCE TO RELATED APPLICATION(S)

This application is based on and claims priority under 35 U.S.C. § 119 to Korean Patent Application No. 10-2022-0063302, filed on May 24, 2022, in the Korean Intellectual Property Office, the disclosure of which is incorporated herein by reference in its entirety.

### BACKGROUND

### 1. Field

The disclosure relates generally to a mobile communication system, and more particularly, to a method and apparatus for optimizing random access (RA) in relation to a small data transmission (SDT).

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as mmWave including 28 GHz and 39 GHz. In addition, implementation of sixth generation (6G) mobile communication technologies (referred to as “beyond 5G systems”) in terahertz (THz) bands such as 95 GHz to 3 THz bands has been considered to achieve transmission rates fifty times faster than 5G mobile communication technologies and ultra-low latencies one-tenth of 5G mobile communication technologies.

At the outset of 5G mobile communication technology development, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in millimeter wave (mmWave), supporting numerologies such as operating multiple subcarrier spacings for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR user equipment (NR UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step RA channel (RACH) for simplifying RA procedures. There also has been ongoing standardization in system architecture/service regarding a 5G service based architecture or service based interface for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

In a wireless communication system, when a UE does not transmit data for a certain period of time, the UE is converted into an idle or an inactive state. When intermittently transmitting small-sized data, the UE is highly likely to transmit data in the idle or inactive state.

Accordingly, there is a need in the art for an operating procedure for re-configuring a bearer and a control connection. Efficiency of the operating procedure for data transmission in an idle or an inactive state may be enhanced when the size of data transmitted by the UE is small (i.e., in an SDT).

### SUMMARY

Accordingly, the present disclosure provides embodiments that are designed to address at least the problems and/or disadvantages described above and to provide at least the advantages described below.

An aspect of the disclosure is to provide a method and apparatus for reporting a RACH-based SDT procedure and SDT related information in a wireless communication system.

Another aspect of the disclosure is to provide a UE that may efficiently perform SDT by enabling data and signaling transmission while maintaining an RRC INACTIVE state.

Another aspect of the disclosure is to provide a UE that may collect SDT-related information and report the same to a base station, thereby enabling the base station to efficiently perform scheduling.

In accordance with an aspect of the disclosure, a method performed by a UE in a wireless communication system includes receiving, from a base station, a radio resource control (RRC) release message including first information for an SDT configuration, transmitting, to the base station, small data based on the first information, and transmitting, to the base station, an RA report including SDT information.

In accordance with an aspect of the disclosure, a method performed by a base station in a wireless communication system includes transmitting, to a UE, an RRC release message including first information for an SDT configuration, receiving, from the UE, small data based on the first information, and receiving, from the UE, an RA report including SDT information.

In accordance with an aspect of the disclosure, a UE in a wireless communication system includes a transceiver configured to transmit or receive a signal, and at least one processor configured to receive, from a base station, an RRC release message including first information for an SDT configuration, transmit, to the base station, small data based on the first information, and transmit, to the base station, an RA report including SDT information.

In accordance with an aspect of the disclosure, a base station in a wireless communication system includes a transceiver configured to transmit or receive a signal, and at least one processor configured to transmit, to a UE, an RRC release message including first information for an SDT configuration, receive, from the UE, small data based on the first information, and receive, from the UE, an RA report including SDT information.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates the structure of a next-generation mobile communication system according to an embodiment;

FIG. 1B illustrates an RA process according to an embodiment;

FIG. 1C illustrates a two-step RA process according to an embodiment;

FIG. 1D illustrates a process of performing RACH reporting according to an embodiment;

FIG. 1E illustrates an SDT process for transmitting small-sized data according to an embodiment;

FIG. 1F illustrates a process of collecting and reporting SDT-related information according to an embodiment;

FIG. 1G illustrates time information related to SDT according to an embodiment;

FIG. 1H illustrates a UE process for collecting and reporting SDT-related information according to an embodiment;

FIG. 1I illustrates a base station process for collecting and reporting SDT-related information according to an embodiment;

FIG. 1J is a block diagram illustrating the internal structure of a UE according to an embodiment; and

FIG. 1K is a block diagram illustrating the structure of an NR base station according to an embodiment.

### DETAILED DESCRIPTION

Hereinafter, an electronic device and method thereof are described with reference to the accompanying drawings. The term “user” used herein may refer to a person using an electronic device or a device using an electronic device, such as an AI electronic device. Detailed descriptions of known functions and/or configurations will be omitted for the sake of clarity and conciseness.

In the accompanying drawings, some elements may be exaggerated, omitted, or schematically illustrated, the size of each element does not completely reflect the actual size, and identical or corresponding elements are provided with identical reference numerals.

The advantages and features of the disclosure and manners to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure. Throughout the specification, the same or like reference numerals designate the same or like elements.

As used herein, a “unit” refers to a software element or a hardware element, such as a field programmable gate array (FPGA) or an application specific integrated circuit (ASIC), which performs a predetermined function. However, the unit does not always have a meaning limited to software or hardware and may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units or may be implemented to reproduce one or more central processing units (CPUs) within a device or a security multimedia card.

Although the disclosure will be described based on the long term evolution (LTE) system, the disclosure may also be applied to other mobile communication systems such as the NR system which is a next-generation mobile communication system. Herein, an evolved node B (eNB) in LTE corresponds to a gNB in NR, and a mobile management entity (MME) in LTE corresponds to an access and mobility management function (AMF) in NR.

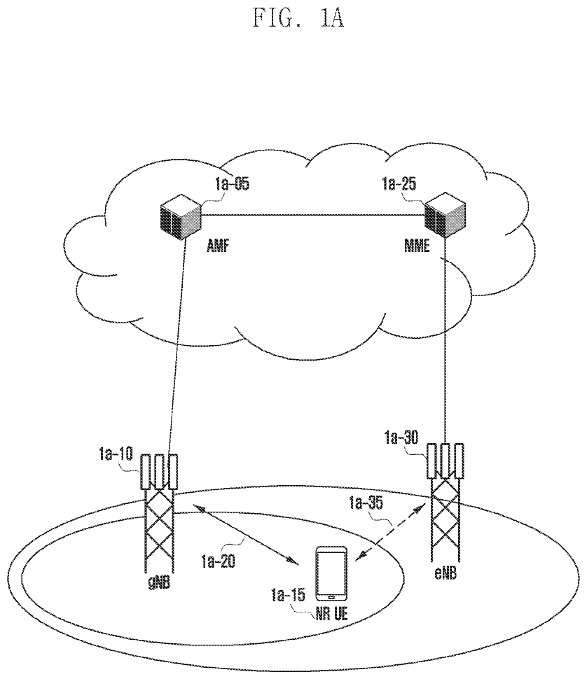

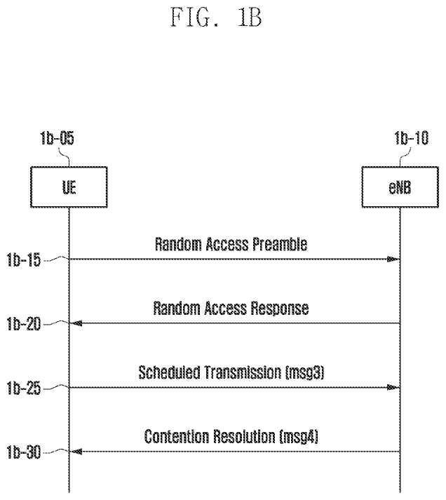

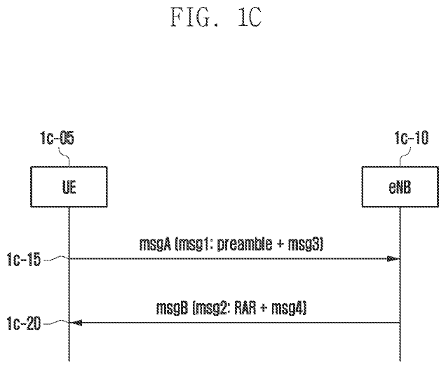

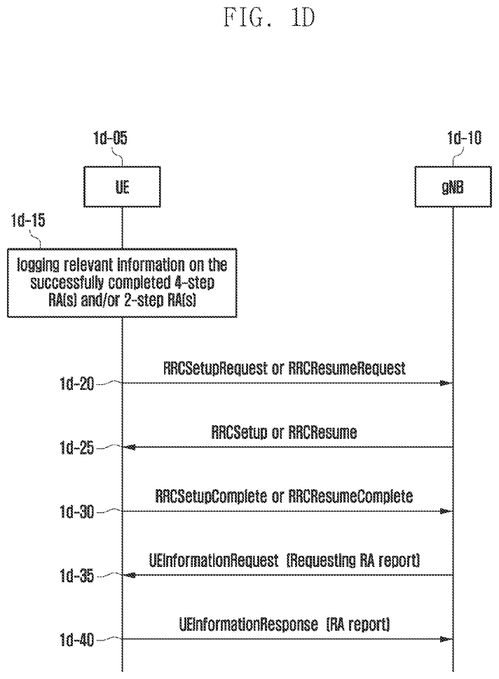

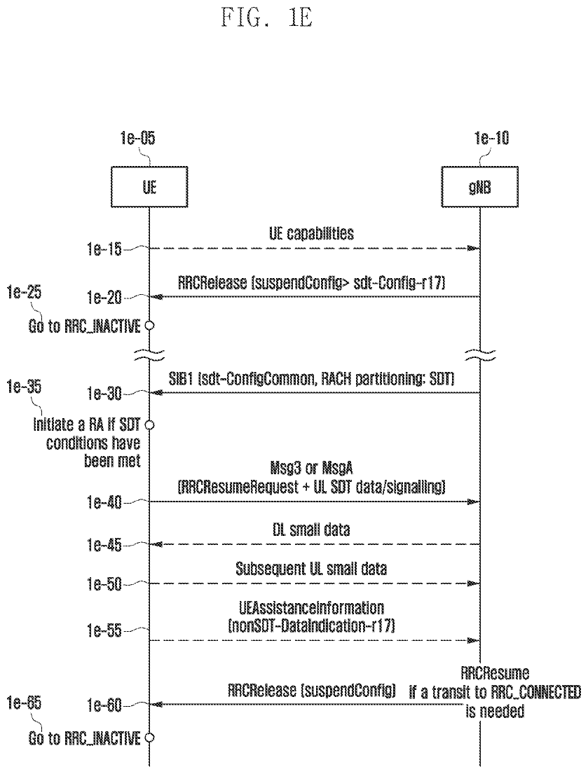

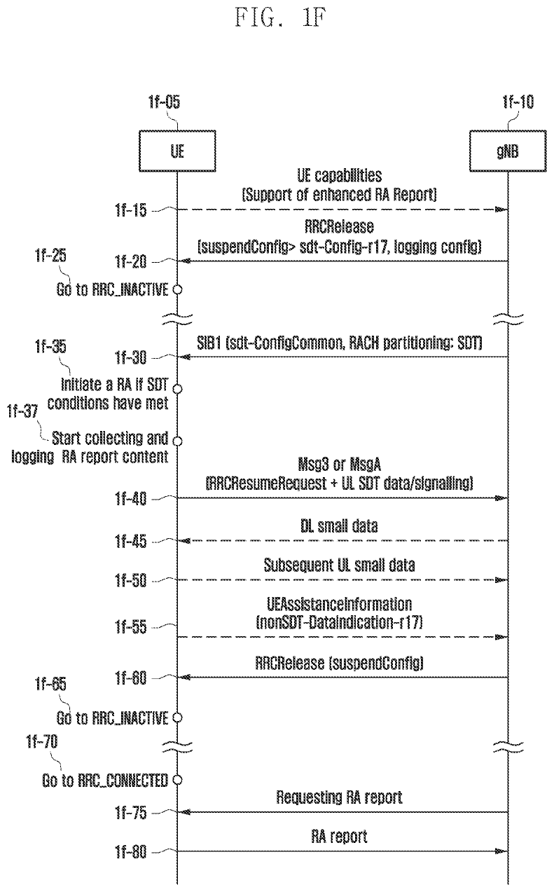

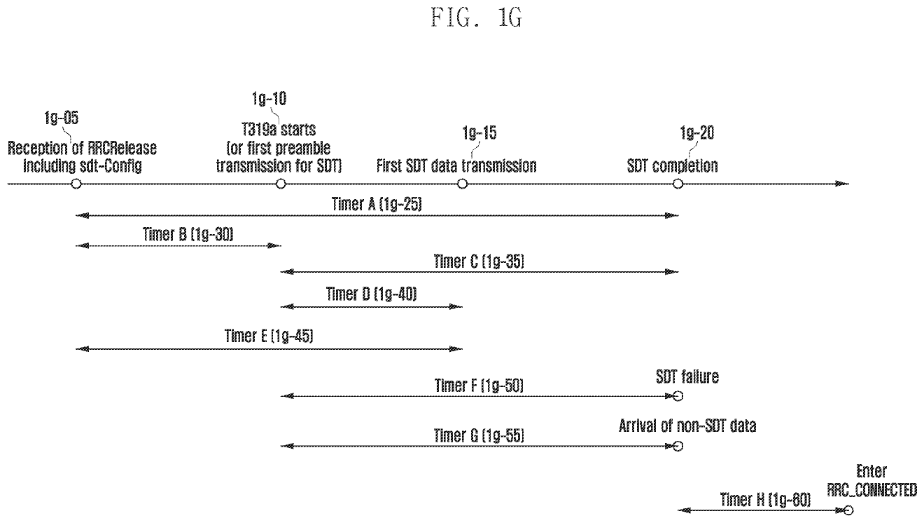

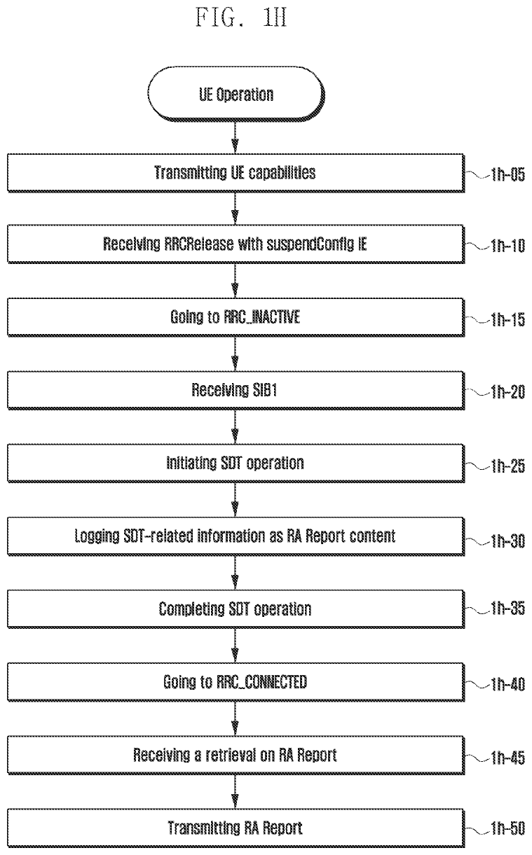

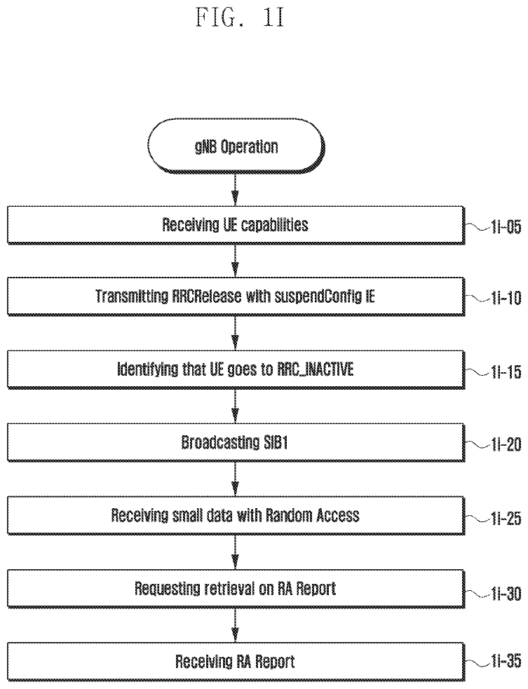

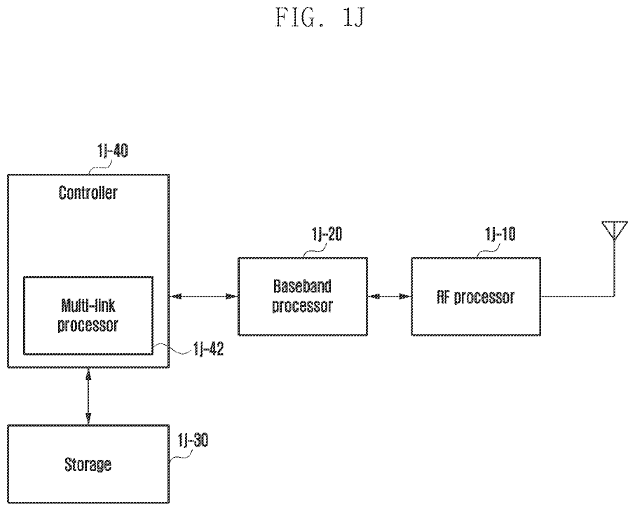

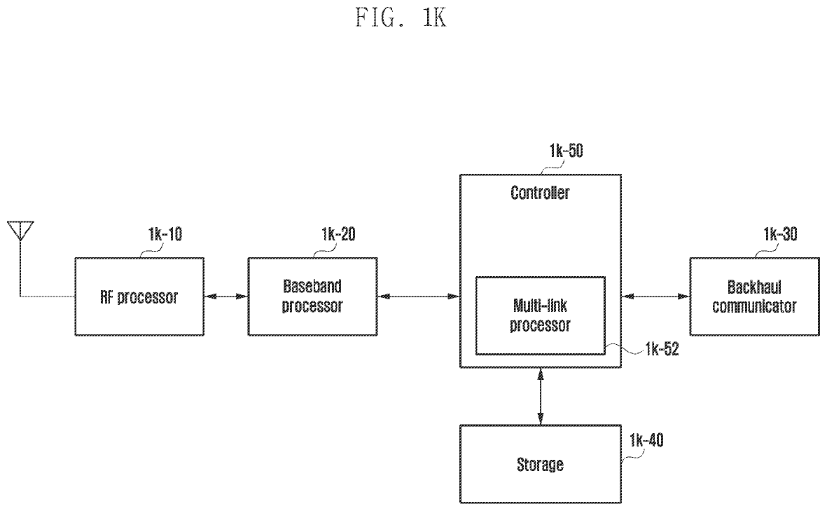

FIG. 1A illustrates the structure of a next-generation mobile communication system according to an embodiment.

Referring to FIG. 1A, a radio access network of the NR system is composed of a next-generation base station (new radio node B, hereinafter gNB) 1a-10 and an AMF (new radio core network) 1a-05. An NR UE or terminal 1a-15 accesses an external network through the gNB 1a-10 and the AMF 1a-05.

In FIG. 1A, the gNB corresponds to an eNB of the existing LTE system. The gNB is connected to the NR UE 1a-15 through a radio channel 1a-20 and may provide a service superior to that of the existing eNB1a-30.

In the next-generation mobile communication system, because all user traffic is serviced through the shared channel, a device for scheduling by collecting state information such as a buffer state of the UEs, an available transmission power state, a channel state, etc. is required, and the gNB 1a-10 is responsible for this scheduling. One gNB usually controls multiple cells. A bandwidth greater than or equal to the existing maximum bandwidth may be applied in order to implement ultra-high-speed data transmission compared to existing LTE, and additional beamforming technology may be grafted by using orthogonal frequency division multiplexing (OFDM) as a radio access technology. In addition, an adaptive modulation & coding (AMC) scheme for determining a modulation scheme and a channel coding rate according to the channel state of the UE is applied.

The AMF 1a-05 performs functions such as mobility support, bearer configuration, quality of service (QoS) configuration, and the like, directs various control functions as well as a mobility management function for the UE, and is connected to a plurality of base stations. In addition, the next-generation mobile communication system may be linked with the existing LTE system, and the AMF 1a-05 is connected to the MME 1a-25 through a network interface. The MME 1a-25 is connected to the existing eNB 1a-30. A UE supporting LTE-NR dual connectivity may transmit and receive data while maintaining a connection to the eNB 1a-30 as well as the gNB 1a-10.

FIG. 1B illustrates an RA process according to an embodiment.

RA is performed when uplink synchronization is performed or data is transmitted to a network. More specifically, the RA may be performed when the UE switches from standby mode to connection mode, when RRC re-establishment is performed, when handover is performed, and when uplink and downlink data starts.

When receiving a dedicated preamble from the base station 1b-10, the UE 1b-05 transmits a preamble by applying the preamble. Otherwise, the UE 1b-05 selects one of the two preamble groups (group A and group B) and selects a preamble belonging to the selected group. When the channel quality state is better than a specific threshold and the size of message 3 (msg 3) is greater than the specific threshold, a preamble belonging to group B is selected; otherwise, a preamble belonging to group A is selected.

In step 1b-15, the preamble is transmitted in the nth subframe from the UE 1b-05 to the eNB 1b-10. In step 1b-20, the UE 1b-05 starts an RA response (RAR) window from the n+3th subframe, and monitors whether the RAR is transmitted within the window time interval. RAR scheduling information is indicated by an RA radio network temporary identifier (RA-RNTI) of a physical downlink control channel (PDCCH). The RA-RNTI is induced by using a radio resource location on the time and frequency axes used to transmit the preamble.

The RAR includes a timing advance command, a UL grant, and a temporary C-RNTI. If the RAR is successfully received in the RAR window, in step 1b-25, the UE 1b-05 transmits msg3 to the eNB 1b-10 by using the UL grant information included in the RAR.

The msg3 includes other information according to the purpose of the RA. Table 1 below is an example of the information included in the msg 3.

TABLE 1

| CASE | Message 3 Contents |
|---|---|
| RRC CONNECTION SETUP | CCCH SDU |
| RRC RE-ESTABLISHMENT | CCCH SDU, BSR (if grant is enough), |
| | PHR (if triggered & grant is enough) |
| Handover | C-RNTI CE, BSR, PHR, (part of) |
| (random preamble) | DCCH SDU |
| Handover | BSR, PHR, (part of) DCCH SDU |
| (dedicate preamble) | |
| UL resume | C-RNTI CE, BSR, PHR, (part of) |
| | DCCH/DTCH SDU |
| PDCCH order | C-RNTI CE, BSR, PHR, (part of) |
| (random preamble) | DCCH/DTCH SDU |
| PDCCH order | BSR, PHR, (part of) DCCH/DTCH SDU |
| (dedicate preamble) | |

The msg3 is transmitted in the n+6th subframe if the RAR is received in the nth subframe. Hybrid automatic request (HARD) is applied from the msg3.

In step 1b-30, after transmitting the msg3, the UE 1b-05 drives a specific timer and monitors a contention resolution (CR) message (msg 4) until the timer expires. In addition to the CR MAC CE, the CR message includes an RRC connection setup or RRC connection reestablishment message according to the purpose of the RA.

FIG. 1C illustrates a two-step RA process according to an embodiment.

The two-step RA process consists of msgA 1c-15 transmitted by the UE 1c-05 in an uplink and msgB 1c-20 transmitted by the base station 1c-10 in a downlink. Conceptually, the msgA has contents of msg1 (i.e., preamble) and msg3, and scheduling information of the msgB in a conventional RA process, and the msgB has the contents of msg2 (i.e., RAR) and msg4 in a conventional RA process. The information included in the conventional msg3 is listed above in Table 1. Depending on the purpose of the RA, information stored in the msg3 is different, and similarly, information stored in the msgA will be different according to the purpose of the two-step RA. Information stored in the conventional msg2 is composed of an RA preamble ID (RAPID), a timing advance (TA) command, a UL grant, and a temporary C-RNTI.

If the two-step RA process is regarded as a failure according to a predetermined condition, it may be converted to the four-step RA process described in FIG. 1B. For example, the predetermined condition is when the two-step RA fails more than a configured number of times or when a message instructing to switch to the four-step RA (e.g., fallbackRAR) is received from the network. The predetermined configuration information is provided to the UE through system information broadcast by the network. The system information is always stored in a periodically broadcast master information block (MIB) or a system information block 1 (SIB1).

FIG. 1D illustrates a process of performing RACH reporting according to an embodiment.

An RA report is a reporting mechanism used to report information related to an RA process performed by a UE to a network. Except for RA triggered for the purpose of requesting system information, successfully completed RA processes are subject to the report. Up to eight RA Report entries that store information related to each RA process may be included in the RA Report. In the next-generation mobile communication system NR, from Rel-17 onwards, the RA Report has been confirmed to record and report information related to 2-step RA as well as 4-step RA.

The UE 1d-05 performs an RA process to the base station (gNB) 1d-10.

In step 1d-15, the UE 1d-05 stores predetermined information related to the successfully completed RA process. The predetermined information is as follows.

Cell ID (cell global identity (CGI), physical cell ID (PCI)) and center frequency information where RA was performed.

The purpose for which RA was performed, such as access, beam failure recovery, handover, or uplink synchronization.

The index value of the synchronization signal block (SSB) or the channel status information reference signal (CSI-RS) for which RA was attempted and the number of transmissions of the preamble in the SSB or the CSI-RS.

Whether the signal quality of the SSB is greater than a threshold (dlRSRPAboveThreshold) and whether contention has occurred during RA (contentionDetected).

Frequency location and bandwidth information of RA radio resources.

Subcarrier spacing information used in BWP of RA radio resources.

Absolute frequency location information of the reference resource block (i.e., common RB0).

Information related to msg1 or msgA transmission, such as the starting time of frequency used for msg1 or msgA transmission, subcarrier spacing information used for msg1 or msgA transmission, FDM information used for msg1 or msgA transmission.

The foregoing information is stored according to the following ASN.1 structure and reported to the base station. One successfully completed RA process is stored in the RA-Report IE and reported, and up to 8 RA reports may be stored in the RA-ReportList IE, as shown below in Table 2.

Information on a plurality of RA attempts in chronological order is stored in one RA-Report IE (Per-RAInfoList IE), also shown below in Table 2.

In the PerRAInfo IE stored in the Per-RAInfoList, the above-mentioned information is stored for each SSB or CSI-RS used for the RA attempt.

Information on each RA attempt, contentionDetected, and dlRSRPAboveThreshold are stored in PerRAAttemptInfo IE in PerRAAttemptInfoList.

TABLE 2
RA-ReportList-r16 ::= SEQUENCE (SIZE (1..maxRAReport-r16)) OF RA-Report-r16

| | |
|---|---|
| RA-Report-r16 ::= | SEQUENCE { |
| cellId-r16 | CHOICE { |
| cellGlobalId-r16 | CGI-Info-Logging-r16, |
| pci-arfcn-r16 | SEQUENCE { |
| physCellId-r16 | PhysCellId, |
| carrierFreq-r16 | ARFCN-ValueNR |

```
    }
  },
```

| | |
|---|---|
| ra-InformationCommon-r16 | RA-InformationCommon-r16, |
| raPurpose-r16 | ENUMERATED {accessRelated, |

beamFailureRecovery, reconfigurationWithSync, ulUnSynchronized,

schedulingRequestFailure,

noPUCCHResourceAvailable, requestForOtherSI,

spare9, spare8, spare7, spare6,

spare5, spare4, spare3, spare2, spare1}
}

| | |
|---|---|
| RA-InformationCommon-r16 ::= | SEQUENCE { |
| absoluteFrequencyPointA-r16 | ARFCN-ValueNR, |
| locationAndBandwidth-r16 | INTEGER (0..37949), |
| subcarrierSpacing-r16 | SubcarrierSpacing, |
| msg1-FrequencyStart-r16 | INTEGER |
| (0..maxNrofPhysicalResourceBlocks-1) | OPTIONAL, |
| msg1-FrequencyStartCFRA-r16 | INTEGER |
| (0..maxNrofPhysicalResourceBlocks-1) | OPTIONAL, |
| msg1-SubcarrierSpacing-r16 | SubcarrierSpacing |

OPTIONAL,

| | |
|---|---|
| msg1-SubcarrierSpacingCFRA-r16 | SubcarrierSpacing |

OPTIONAL,

| | |
|---|---|
| msg1-FDM-r16 | ENUMERATED {one, two, four, eight} |

OPTIONAL,

| | |
|---|---|
| msg1-FDMCFRA-r16 | ENUMERATED {one, two, four, eight} |

OPTIONAL,

| | |
|---|---|
| perRAInfoList-r16 | PerRAInfoList-r16 |

}
PerRAInfoList-r16 ::= SEQUENCE (SIZE (1..200)) OF PerRAInfo-r16

| | |
|---|---|
| PerRAInfo-r16 ::= | CHOICE { |
| perRASSBInfoList-r16 | PerRASSBInfo-r16, |
| perRACSI-RSInfoList-r16 | PerRACSI-RSInfo-r16 |

}

| | |
|---|---|
| PerRASSBInfo-r16 ::= | SEQUENCE { |
| ssb-Index-r16 | SSB-Index, |
| numberOfPreamblesSentOnSSB-r16 | INTEGER (1..200), |
| perRAAttemptInfoList-r16 | PerRAAttemptInfoList-r16 |

}

| | |
|---|---|
| PerRACSI-RSInfo-r16 ::= | SEQUENCE { |
| csi-RS-Index-r16 | CSI-RS-Index, |
| numberOfPreamblesSentOnCSI-RS-r16 | INTEGER (1..200) |

}

| | |
|---|---|
| PerRAAttemptInfoList-r16 ::= | SEQUENCE (SIZE (1..200)) OF PerRAAttemptInfo- |

r16

| PerRAAttemptInfo-r16 ::= | SEQUENCE { | |
|---|---|---|
| contentionDetected-r16 | BOOLEAN | OPTIONAL, |
| dlRSRPAboveThreshold-r16 | BOOLEAN | OPTIONAL, |

...
}

In step 1d-20, the UE 1d-05 in the standby mode or inactive mode transmits an RRCSetupRequest or RRCResumeRequest message to the base station 1d-10 to switch to the connection mode.

In step 1d-25, the base station 1d-10 transmits an RRCSetup message or an RRCResume message to the UE 1d-05, and upon receiving the message, the UE 1d-05 switches to the connection mode.

In step 1d-30, the UE 1d-05 transmits an RRCSetupComplete message or an RRCResumeComplete message to the base station 1d-10.

In step 1d-35, the base station 1d-10 requests the UE 1d-05 to report the information by using a UEInformationRequest message.

In step 1d-40, the UE 1d-05 receiving the request transmits a UEInformationResponse message including the stored information to the gNB 1d-10. The RA report information reported to the base station is deleted. Even if the stored RA report is not reported to the base station, the UE may delete the report after a specific period of time.

FIG. 1E illustrates an SDT process for transmitting small-sized data according to an embodiment.

In step 1e-15, the UE 1e-05 transmits its capability information to the gNB 1e-10. The capability information may include indicators indicating whether the UE 1e-05 supports RA report and SDT.

In step 1e-20, the gNB 1e-10 transmits the RRCRelease message including the suspendConfig IE to the UE 1e-05 to switch the UE 1e-05 to the inactive mode. The suspendConfig IE includes configuration information related to the inactive mode.

The gNB 1e-10 may configure SDT for the UE 1e-05 that is switched to the inactive mode. In this case, the RRCRelease message includes SDT-Config IE including configuration information related to SDT. Table 3 below illustrates information stored in the IE.

TABLE 3

| | |
|---|---|
| SDT-Config-r17 ::= | SEQUENCE { |
| sdt-DRB-List-r17 | SEQUENCE (SIZE (0..maxDRB)) |
| | OF DRB-Identity |

OPTIONAL, -- Need M

| | |
|---|---|
| sdt-SRB2-Indication-r17 | ENUMERATED {allowed} |

OPTIONAL, -- Need R

| | |
|---|---|
| sdt-MAC-PHY-CG-Config- | SetupRelease {SDT-CG-Config-r17} |
| r17 | |

OPTIONAL, -- Need M

| | |
|---|---|
| sdt-DRB-ContinueROHC-r17 | ENUMERATED { cell, rna } |

OPTIONAL -- Need R
}

Through SDT, data radio bearers (DRBs) capable of transmitting data are configured, and whether SRB2 is allowed for SDT may be configured. In addition, MAC and PHY-related configuration information and complementation-related configuration information may be considered.

In step 1e-25, the UE 1e-05 that has received the RRCRelease message is switched to an inactive mode.

In step 1e-30, the UE 1e-05 receives system information from a the gNB 1e-10 which broadcasts configuration information related to SDT through system information. Table 4 below illustrates the configuration information broadcasted through the system information.

TABLE 4

| | |
|---|---|
| SDT-ConfigCommonSIB-r17 ::= | SEQUENCE { |
| sdt-RSRP-Threshold-r17 | RSRP-Range, |
| sdt-LogicalChannelSR-DelayTimer-r17 | ENUMERATED { sf20, sf40, sf64, sf128, sf512, sf1024, |

sf2560, spare1} OPTIONAL, -- Need R

| | |
|---|---|
| sdt-DataVolumeThreshold-r17 | ENUMERATED {byte32, byte100, byte200, byte400, |

byte600, byte800, byte1000, byte2000, byte4000,

| | |
|---|---|
| | byte8000, byte9000, byte10000, byte12000, |
| byte24000, byte48000, byte96000}, | |
| t319a-r17 | ENUMERATED { ms100, ms200, ms300, ms400, ms600, |
| ms1000, ms2000, | |
| | ms3000, ms4000, spare7, spare6, spare5, |

spare4, spare3, spare2, spare1},
...
}

The sdt-RSRP-Threshold field is used to indicate a received signal strength reference signal received power (RSRP) threshold value to be considered in order for the UE to determine whether to perform the SDT process.

The sdt-LogicalChannelSR-DelayTimer field is used to indicate a value of logicalChannelSR-DelayTimer applied to a logical channel during SDT.

The sdt-DataVolumeThreshold field is used to indicate the threshold value of the data size to be considered in order for the UE to determine whether to perform the SDT process.

The t319a field is used to indicate the value of a T319a timer. The T319a timer is driven when an RRCResumeRequest message is transmitted for SDT purposes, and if the SDT is not completed until the timer expires, the SDT process is considered to have failed. Specifically, the timer is stopped when an RRCResume, RRCsetup, RRCRelease, or RRCReject message is received, and when the SDT is deemed to have failed (even before the timer expires) according to a predetermined condition.

The system information may include RACH configuration information usable for SDT.

In step 1e-35, the UE 1e-05 compares the received signal strength and the data size to be transmitted with the sdt-RSRP-Threshold field value and the sdt-DataVolumeThreshold field value, respectively, and determines to transmit the data through the SDT process.

In addition, the UE initiates a four-step or two-step RA process according to conventional rules.

In step 1e-40, the UE 1e-05 stores the small-size data together with an RRCResumeRequest message in the Msg3 message if the four-step RA process is triggered, or in the MsgA if the two-step RA process is triggered, and transmits the small-size data to the gNB 1e-10.

In step 1e-45, the gNB 1e-10 may additionally schedule the UE 1e-05.

In step 1e-50, the UE 1e-05 may transmit small data to the gNB 1e-10 according to the scheduling.

During the SDT process, data corresponding to a radio bearer for which SDT data transmission is not permitted may be generated in the UE. In this case, in step 1e-55, the UE 1e-05 may transmit a UEAssistanceInformation message including an indicator (non-SDT-DataIndication field) indicating the situation to the gNB 1e-10. The indicator may include a resume cause value including cause information for resuming, such as emergency, high priority access, and mobile terminated (MT) access. In the TS38.331 standard document, the resume cause is in Table 5 as follows.

TABLE 5

| | |
|---|---|
| ResumeCause ::= | ENUMERATED {emergency, highPriorityAccess, |
| | mt-Access, mo-Signalling, |
| | mo-Data, mo-VoiceCall, mo-VideoCall, |
| | mo-SMS, rna-Update, |

mps-PriorityAccess,

mcs-PriorityAccess, spare1, spare2, spare3, spare4,

spare5 }

Upon receiving the indicator, the base station may switch the UE to a connection mode to receive the data.

In step 1e-60, when the SDT transmission is completed, the base station 1e-10 may switch the UE 1e-05 back to the inactive mode by using the RRCRelease message including the suspendConfig IE.

Depending on the case, the base station 1e-10 may transmit RRCRelease, RRCsetup, RRCRelease, and RRCReject messages not including the suspendConfig IE to the UE 1e-05 to switch the UE 1e-05 to standby mode or connection mode.

In step 1e-65, the UE 1e-05 that has received the RRCRelease message including the suspendConfig IE switches to an inactive mode.

FIG. 1F illustrates a process of collecting and reporting SDT-related information according to an embodiment.

In step 1f-15, the UE 1f-05 transmits its capability information to the gNB 1f-10. The capability information may include indicators indicating whether the UE 1f-05 supports an RA report and SDT. In addition, the capability information may include an indicator indicating that SDT-related information may be recorded and reported through the RA report.

In step 1f-20, the gNB 1f-10 transmits the RRCRelease message including the suspendConfig IE to the UE 1f-05 to switch the UE 1f-05 to inactive mode. The suspendConfig IE includes configuration information related to inactive mode.

The gNB 1f-10 may configure an SDT for the UE 1f-05 that is switched to the inactive mode. In this case, the RRCRelease message includes SDT-Config IE including configuration information related to SDT. In addition, the base station may configure an operation of collecting SDT-related information through the RRCRelease message and reporting the same through the RA report to the UE. To this end, an indicator indicating to collect and store SDT-related information and report the same through the RA report is included in the RRCRelease message.

In addition to the indicator, frequency list information or cell/tracking area ID information for collecting the SDT-related information may be provided. The gNB 1f-10 may perform the configuration through a LoggedMeasurementConfiguration or RRCReconfiguration message.

In step 1f-25, the UE 1f-05 that has received the RRCRelease message is switched to an inactive mode (RRC inactive).

In step 1f-30, the UE 1f-05 receives system information from a predetermined gNB 1f-10. The gNB 1f-10 may broadcast configuration information related to SDT through system information.

In step 1f-35, the UE 1f-05 compares the received signal strength and the data size to be transmitted with the sdt-RSRP-Threshold field value and the sdt-DataVolumeThreshold field value, respectively, and determines to transmit the data through the SDT process.

In step 1f-37, the UE 1f-05 triggers a four-step or two-step RA process according to conventional rules. In this case, the UE 1f-05 may collect and store information related to the SDT operation as the contents of the RA report.

In step 1f-40, the UE 1f-05 stores the small-size data together with an RRCResumeRequest message in the Msg3 message if the four-step RA process is triggered, or in the MsgA if the two-step RA process is triggered, and transmits the small-size data to the gNB 1f-10.

In step 1f-45, the gNB 1f-10 may additionally schedule the UE 1f-05.

In step 1f-50, the UE 1f-05 may transmit UL small data according to the scheduling.

During the SDT process, data corresponding to a radio bearer for which SDT data transmission is not permitted may be generated in the UE. In this case, in step 1f-55, the UE 1f-05 may transmit a UEAssistanceInformation message including an indicator indicating the situation to the gNB 1f-10 1f-55. Upon receiving the indicator, the gNB 1f-10 may switch the UE 1f-05 to a connection mode to receive the data.

In step 1f-60, when the SDT transmission is completed, the gNB 1f-10 may switch the UE 1f-05 back to the inactive mode by using the RRCRelease message including the suspendConfig IE.

Depending on the case, the gNB 1f-10 may transmit RRCRelease, RRCsetup, RRCRelease, and RRCReject messages not including the suspendConfig IE to the UE to switch the UE to standby mode or connection mode.

During the SDT process, the UE stores the SDT-related information in the RA report as follows.

A new code point of the raPurpose field, as shown below in Table 6, indicating RA triggered for SDT. The raPurpose field may be stored for each entry of the RA report, and the field is used to indicate the purpose of triggering RA (refer to the capture below). A new code point indicating that RA is triggered for the SDT operation may be added to the field. Alternatively, instead of the new code point, a new indicator field indicating RA triggered for SDT may be included.

TABLE 6

| | |
|---|---|
| raPurpose-r16 | ENUMERATED {accessRelated, beamFailureRecovery, reconfigur |
| ationWithSync, ulUnSynchronized, | schedulingReq |

uestFailure, noPUCCHResourceAvailable, requestForOtherSI,
msg3RequestForOtherSI-r17, spare8, spare7, spare6, spare5, spare4, spare3,
spare2, spare1},

SDT configuration information stored and provided in RRCRelease. For example, DRB(s) ID information configured for SDT, indicator indicating whether SRB2 is configured for SDT. The configuration information may be used for optimization when the network later reconfigures the SDT for the UE.

SDT configuration information stored and provided in system information. For example, sdt-RSRP-Threshold field, sdt-LogicalChannelSR-DelayTimer field, sdt-DataVolumeThreshold field. The information may be used by the network to adjust the frequency at which SDT operations are triggered within the service area, or to optimize the SDT success rate or SDT delay performance.

The measured RSRP value that triggered the SDT operation and the actual data size value that triggered the SDT operation. The two types of information may be referred to when the network adjusts the configuration values of the sdt-RSRP-Threshold field and the sdt-DataVolumeThreshold field.

An indicator indicating whether the base station to which the UE has attempted RA supports SDT. Indicator information indicating whether the cell in which the RA was attempted may support SDT may be included in the RA report entry for one RA.

An indicator indicating that SDT is performed in normal uplink (NUL) or supplementary uplink (SUL). SDT may be performed in either NUL or SUL. Accordingly, it is necessary to inform the network on which uplink the SDT was performed.

An indicator indicating whether data corresponding to a radio bearer not configured for SDT has occurred during SDT. Alternatively, an indicator indicating whether transmission of a UEAssistanceInformation message including a nonSDT-DataIndication field has been triggered. In this case, the ID information of the radio bearer, the data size, and the resume cause value included in the nonSDT-DataIndication field may be included in the RA report together. This information may be utilized by the network to determine the DRB to be configured for SDT.

An indicator indicating whether the UE has switched to the connection mode after the SDT operation. That is, whether the UE received an RRCResume or RRCSetup message during the SDT process.

An indicator indicating whether the UE has switched to standby mode after the SDT operation. That is, whether the UE received an RRCRelease message without suspendConfig IE during the SDT process.

Whether the UE received the RRCReject message after the SDT operation. In this case, the waitTime information value included in the RRCReject message may also be included in the RA report. The waitTime information is used to derive a back-off time to wait until access is retried.

An indicator indicating whether SDT failed or succeeded. In particular, when the SDT fails, the cause that the SDT considered as a failure may be included in the RA report. For example, SDT failure causes that may be indicated are as follows.
receiving an integrity check failure indication from lower layers while T319a is running,
receiving indication from the MCG RLC that the maximum number of retransmissions has been reached while T319a is running,
receiving an RA problem indication from MCG MAC while T319a is running or
if T319a expires
RACH radio resource related information. The UE uses SDT-specific RACH radio resources for SDT operation. In this case, the following two methods may be used.

Approach 1: RACH occasions are separate for SDT RA and non-SDT RA. Preambles are the same.

Approach 2: RACH occasions are the same. In this case, preambles are different for SDT RA and non-SDT RA.

Accordingly, an indicator indicating which of the two methods is applied may be included in the RA report.

Predetermined time information (described below in FIG. 1G)

In step 1f-65, the UE 1f-05 that has received the RRCRelease message including the suspendConfig IE switches to an inactive mode.

In step 1f-70, the UE 1f-05 is connected to a predetermined gNB 1f-10.

In step 1f-75, if the gNB 1f-10 requests the RA report stored in the UE 1f-05 through the UEInformationRequest message, and in step 1f-80, the UE 1f-05 transmits the UEInformationResponse message containing the RA report to the gNB 1f-10.

FIG. 1G illustrates time information related to SDT according to an embodiment.

The UE may store time information related to an SDT operation and report the same to the base station through an RA report. In this embodiment, the following time information is disclosed.

Timer A (1g-25): Time between reception of RRCRelease including sdt-Config (1g-05) and SDT completion (1g-20)(or transit to RRC CONNECTED, 1g-60).

Timer B (1g-30): Time between reception of RRCRelease including sdt-Config (1g-05) and the start of SDT timer, T319a (1g-10)(or first preamble transmission).

Timer C (1g-35): Time between the start of the SDT timer, T319a (or first preamble transmission) and SDT completion (or transit to RRC CONNECTED).

Timer D (1g-40): Time between the start of the SDT timer, T319a (or first preamble transmission) and first transmission of the SDT data.

Timer E (1g-45): Time between reception of RRCRelease including sdt-Config and first transmission of the SDT data.

Timer F (1g-50): Time between the start of the SDT timer, T319a (or first preamble transmission) and SDT failure.

Timer G (1g-55): Time between the start of the SDT timer, T319a (or first preamble transmission) and the arrival of non-SDT data (or non-SDT data indication).

Timer H (1g-60): Time between the arrival of non-SDT data (or non SDT data indication) and entering RRC CONNECTED.

FIG. 1H illustrates a UE process for collecting and reporting SDT-related information according to an embodiment.

In step 1h-05, the UE transmits its capability information to a base station. The capability information includes an indicator indicating that SDT-related information may be recorded and reported through an RA report (Transmitting UE capabilities).

In step 1h-10, the UE receives an RRCRelease message including SDT configuration information and suspendConfig IE from the base station (Receiving RRCRelease with suspendConfig IE).

In step 1h-15, the UE is switched to inactive mode (Entering RRC INACTIVE).

In step 1h-20, the UE receives system information including configuration information related to SDT from a predetermined base station (Receiving SIB1).

In step 1h-25, the UE compares the received signal strength and the data size to be transmitted with the sdt-RSRP-Threshold field value and the sdt-DataVolumeThreshold field value, respectively, and determines to transmit the data through the SDT process (Initiating SDT operation). In this case, the UE triggers an RA process by using SDT-specific RACH radio resources.

In step 1h-30, the UE collects and stores information related to the SDT operation as the contents of the RA report (Logging SDT-related information as RA Report content).

In step 1h-35, the UE successfully completes the SDT operation (Completing SDT operation).

In step 1h-40, the UE is connected to the predetermined base station (Going to RRC CONNECTED).

In step 1h-45, the UE receives the UEInformationRequest message from the base station requesting a report of the RA report stored therein (Receiving a retrieval on RA report).

In step 1h-50, the UE transmits the UEInformationResponse message including the report to the base station (Transmitting RA Report).

FIG. 1I illustrates a base station process for collecting and reporting SDT-related information according to an embodiment.

In step 1i-05, the gNB receives capability information for a predetermined UE (Receiving UE capabilities). The capability information includes an indicator indicating that SDT-related information may be recorded and reported through an RA report.

In step 1i-10, the base station transmits an RRCRelease message including SDT configuration information and suspendConfig IE to the UE (Transmitting RRCRelease with suspendConfig IE).

In step 1i-15, the gNB recognizes that the UE has switched to an inactive mode (Identifying that UE goes to RRC_INACITVE). In step 1i-20, the gNB broadcasts system information including configuration information related to SDT (Broadcasting SIB1).

In step 1i-25, the gNB receives SDT data from the UE through an RA process triggered for the purpose of the SDT (Receiving small data with RA).

In step 1i-30, the gNB transmits the UEInformationRequest message requesting a report of the RA report to the UE (Requesting retrieval on RA Report).

In step 1i-35, the gNB receives the UEInformationResponse message including the report from the UE (Receiving RA Report).

FIG. 1J is a block diagram illustrating the internal structure of a UE according to an embodiment.

In FIG. 1J, the UE includes a radio frequency (RF) processor 1j-10, a baseband processor 1j-20, a storage 1j-30, and a controller 1j-40.

The RF processor 1j-10 performs a function for transmitting and receiving a signal through a radio channel, such as band conversion and amplification of a signal. That is, the RF processor 1j-10 up-converts a baseband signal provided from the baseband processor 1j-20 into an RF band signal, transmits the RF band signal through an antenna, and down-converts the RF band signal received through the antenna to the baseband signal. For example, the RF processor 1j-10 may include a transmission filter, a reception filter, an amplifier, a mixer, an oscillator, a digital to analog converter (DAC), an analog to digital converter (ADC), etc. In FIG. 1J, only one antenna is illustrated, but the UE may include a plurality of antennas. In addition, the RF processor 1j-10 may include a plurality of RF chains and may perform beamforming. For the beamforming, the RF processor 1j-10 may adjust the phase and magnitude of each of signals transmitted and received through a plurality of antennas or antenna elements. In addition, the RF processor 1j-10 may perform a MIMO operation during which the RF processor 1j-10 may receive multiple layers.

The baseband processor 1j-20 performs a function of converting between a baseband signal and a bit stream according to a physical layer standard of the system. For example, when transmitting data, the baseband processor 1j-20 generates complex symbols by encoding and modulating a transmitted bit stream. In addition, when receiving data, the baseband processor 1j-20 restores a received bit stream by demodulating and decoding the baseband signal provided from the RF processor 1j-10. For example, in an orthogonal frequency division multiplexing (OFDM) scheme, when transmitting data, the baseband processor 1j-20 generates complex symbols by encoding and modulating a transmitted bit stream, maps the complex symbols to subcarriers, and then configures OFDM symbols through an inverse fast Fourier transform (IFFT) operation and cyclic prefix (CP) insertion. In addition, when receiving data, the baseband processor 1j-20 divides the baseband signal provided from the RF processor 1j-10 into OFDM symbol units, restores signals mapped to subcarriers through a fast Fourier transform (FFT) operation, and then restores a received bit stream through demodulation and decoding.

The baseband processor 1j-20 and the RF processor 1j-10 transmit and receive signals as described above. Accordingly, the baseband processor 1j-20 and the RF processor 1j-10 may be referred to as a transmitter, a receiver, a transceiver, or a communicator. Furthermore, at least one of the baseband processor 1j-20 and the RF processor 1j-10 may include a plurality of communication modules to support a plurality of different radio access technologies. At least one of the baseband processor 1j-20 and the RF processor 1j-10 may include different communication modules to process signals of different frequency bands. For example, the different radio access technologies may include a wireless local area network (LAN) (e.g., IEEE 802.11), a cellular network (e.g., LTE), or the like. In addition, the different frequency bands may include a super high frequency (SHF) (e.g., 2.NRHz) band and a millimeter wave (e.g., 60 GHz) band.

The storage 1j-30 stores data such as a basic program, an application program, and configuration information for the operation of the UE. In particular, the storage 1j-30 may store information related to a second access node performing wireless communication by using the second radio access technology. In addition, the storage 1j-30 provides stored data according to the request of the controller 1j-40.

The controller 1j-40 controls overall operations of the UE. For example, the controller 1j-40 transmits and receives signals through the baseband processor 1j-20 and the RF processor 1j-10, writes data in the storage 1j-30 and reads the data. To this end, the controller 1j-40 may include at least one of a communication processor that controls for communication and an application processor (AP) that controls an upper layer such as an application program.

FIG. 1K is a block diagram illustrating the structure of an NR base station according to an embodiment.

As illustrated in the diagram, the base station includes an RF processor 1k-10, a baseband processor 1k-20, a backhaul communicator 1k-30, a storage 1k-40, and a controller 1k-50.

The RF processor 1k-10 performs a function for transmitting and receiving a signal through a radio channel, such as band conversion and amplification of the signal. That is, the RF processor 1k-10 up-converts the baseband signal provided from the baseband processor 1k-20 into an RF band signal, transmits the same through an antenna, and down-converts the RF band signal received through the antenna into a baseband signal. For example, the RF processor 1k-10 may include a transmission filter, a reception filter, an amplifier, a mixer, an oscillator, a DAC, an ADC, and the like. Although only one antenna is, the first access node may include a plurality of antennas. In addition, the RF processor 1k-10 may include a plurality of RF chains. Furthermore, the RF processor 1k-10 may perform beamforming. For the beamforming, the RF processor 1k-10 may adjust the phase and magnitude of each of signals transmitted and received through a plurality of antennas or antenna elements. The RF processor 1k-10 may perform a downlink MIMO operation by transmitting one or more layers.

The baseband processor 1k-20 performs a function of converting between a baseband signal and a bit stream according to the physical layer standard of the first radio access technology. For example, when transmitting data, the baseband processor 1k-20 generates complex symbols by encoding and modulating a transmitted bit stream. In addition, when receiving data, the baseband processor 1k-20 restores a received bit stream through demodulating and decoding the baseband signal provided from the RF processor 1k-10. For example, in the OFDM scheme, when transmitting data, the baseband processor 1k-20 generates complex symbols by encoding and modulating a transmitted bit stream, maps the complex symbols to subcarriers, and then configures OFDM symbols through IFFT operation and CP insertion. In addition, when receiving data, the baseband processor 1k-20 divides the baseband signal provided from the RF processor 1k-10 into OFDM symbol units, restores signals mapped to subcarriers through FFT operation, and then restores a received bit stream through demodulation and decoding. The baseband processor 1k-20 and the RF processor 1k-10 transmit and receive signals as described above. Accordingly, the baseband processor 1k-20 and the RF processor unit 1k-10 may be referred to as a transmitter, a receiver, a transceiver, a communicator, or a wireless communicator.

The backhaul communicator 1k-30 provides an interface for performing communication with other nodes in the network. That is, the backhaul communicator 1k-30 converts a bit stream transmitted from the main base station to another node, such as an auxiliary base station or a core network, into a physical signal, and converts a physical signal received from the other node into a bit stream.

The storage 1k-40 stores data such as a basic program, an application program, and configuration information for the operation of the main base station. In particular, the storage 1k-40 may store information on a bearer allocated to an accessed UE, a measurement result reported from the accessed UE, and the like. In addition, the storage 1k-40 may store information serving as a criterion for determining whether to provide or stop multiple connections to the UE. In addition, the storage 1k-40 provides stored data according to the request of the controller 1k-50.

The controller 1k-50 controls overall operations of the main base station. For example, the controller 1k-50 transmits and receives signals through the baseband processor 1k-20 and the RF processor 1k-10 or through the backhaul communicator 1k-30. In addition, the controller 1k-50 writes data in the storage 1k-40 and reads the data. To this end, the controller 1k-50 may include at least one processor.

The configuration diagrams and views of the control/data signal transmission method, and the operation procedure illustrated in FIG. 1A to FIG. 1I are not intended to limit the scope of the disclosure. That is, it should not be construed that all constituent units, entities, or operation steps shown in FIG. 1A to FIG. 1I are essential elements for implementing the disclosure, and it should be understood that the disclosure may be implements by only some elements without departing from the basic scope of the disclosure.

The above-described operations of a base station or a terminal may be implemented by providing a memory device storing corresponding program codes in a bast station or terminal device. That is, a controller of the base station or terminal device may perform the above-described operations by reading and executing the program codes stored in the memory device by means of a processor or central processing unit (CPU).

Various units or modules of a network entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

Herein, it is understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

While the disclosure has been particularly shown and described with reference to certain embodiments thereof, it will be understood by those skilled in the art that various changes in form and details may be made therein without departing from the scope of the subject matter as defined by the appended claims and their equivalents.

What is claimed is:

1. A method performed by a user equipment (UE) in a wireless communication system, the method comprising:
receiving, from a base station, a radio resource control (RRC) release message including first information for a small data transmission (SDT) configuration;
transmitting, to the base station, small data based on the first information; and
transmitting, to the base station, a random access (RA) report including SDT information.

2. The method of claim 1,
wherein the SDT information includes at least one of information corresponding to the first information, an actual reference signal received power (RSRP) value triggering the SDT, an actual data size triggering the SDT, an indication of whether the base station supports the SDT, an indication of whether the SDT was performed on a normal uplink (NUL) or a supplementary uplink (SUL), an indication of whether the UE has switched to a connected mode after the SDT, an indication of whether the UE has switched to an inactive mode after the SDT, an indication of whether the UE has received an RRC reject message after the SDT, or an indication of whether the SDT has failed.

3. The method of claim 1, wherein transmitting the RA report comprises:
receiving, from the base station, a UE information request message for the RA report in an RRC connected state; and
based on the UE information request message, transmitting, to the base station, a UE information response message including the RA report, and
wherein the RA report includes the SDT information.

4. The method of claim 1, further comprising:
receiving, from the base station, system information including second information for the SDT configuration; and
determining to transmit the small data based on the second information,
wherein the second information includes at least one of a first threshold value of a reference signal received power (RSRP) or a second threshold value of a data size.

5. The method of claim 1, further comprising:
transmitting, to the base station, UE capability information including at least one of a first indication of whether the UE supports the RA report, or a second indication of whether the UE supports the SDT.

6. A method performed by a base station in a wireless communication system, the method comprising:
transmitting, to a user equipment (UE), a radio resource control (RRC) release message including first information for a small data transmission (SDT) configuration;
receiving, from the UE, small data based on the first information; and
receiving, from the UE, a random access (RA) report including SDT information.

7. The method of claim 6,
wherein the SDT information includes at least one of information corresponding to the first information, an actual reference signal received power (RSRP) value triggering the SDT, an actual data size triggering the SDT, an indication of whether the base station supports the SDT, an indication of whether the SDT was performed on a normal uplink (NUL) or a supplementary uplink (SUL), an indication of whether the UE has switched to a connected mode after the SDT, an indication of whether the UE has switched to an inactive mode after the SDT, an indication of whether the UE has received an RRC reject message after the SDT, or an indication of whether the SDT has failed.

8. The method of claim 6, wherein receiving the RA report comprises:
transmitting, to the UE, a UE information request message for the RA report in an RRC connected state; and
based on the UE information request message, receiving, from the UE, a UE information response message including the RA report, and
wherein the RA report includes the SDT information.

9. The method of claim 6, further comprising:
transmitting, to the UE, system information including second information for the SDT configuration,
wherein the second information includes at least one of a first threshold value of a reference signal received power (RSRP) or a second threshold value of a data size.

10. The method of claim 6, further comprising:
receiving, from the UE, a UE capability information including at least one of a first indication of whether the UE supports the RA report, or a second indication of whether the UE supports the SDT.

11. A user equipment (UE) in a wireless communication system, the UE comprising:
a transceiver configured to transmit or receive a signal; and
at least one processor,
wherein the at least one processor is configured to:
receive, from a base station, a radio resource control (RRC) release message including first information for a small data transmission (SDT) configuration;
transmit, to the base station, small data based on the first information; and
transmit, to the base station, a random access (RA) report including SDT information.

12. The UE of claim 11,
wherein the SDT information includes at least one of information corresponding to the first information, an actual reference signal received power (RSRP) value triggering the SDT, an actual data size triggering the SDT, an indication of whether the base station supports the SDT, an indication of whether the SDT was performed on a normal uplink (NUL) or a supplementary uplink (SUL), an indication of whether the UE has switched to a connected mode after the SDT, an indication of whether the UE has switched to an inactive mode after the SDT, an indication of whether the UE has received an RRC reject message after the SDT, or an indication of whether the SDT has failed.

13. The UE of claim 11, wherein the at least one processor is further configured to:
receive, from the base station, a UE information request message for the RA report in an RRC connected state; and
based on the UE information request message, transmit, to the base station, a UE information response message including the RA report, and
wherein the RA report includes the SDT information.

14. The UE of claim 11, wherein the at least one processor is further configured to:
receive, from the base station, system information including second information for the SDT configuration; and
determine to transmit the small data based on the second information, and
wherein the second information includes at least one of a first threshold value of a reference signal received power (RSRP) or a second threshold value of a data size.

15. The UE of claim 11, wherein the at least one processor is further configured to:
transmit, to the base station, UE capability information including at least one of a first indication of whether the UE supports the RA report, or a second indication of whether the UE supports the SDT.

16. A base station in a wireless communication system, the base station comprising:
a transceiver configured to transmit or receive a signal; and
at least one processor,
wherein the at least one processor is configured to:
transmit, to a user equipment (UE), an radio resource control (RRC) release message including first information for a small data transmission (SDT) configuration;
receive, from the UE, small data based on the first information; and
receive, from the UE, a random access (RA) report including SDT information.

17. The base station of claim 16,
wherein the SDT information includes at least one of information corresponding to the first information, an actual reference signal received power (RSRP) value triggering the SDT, an actual data size triggering the SDT, an indication of whether the base station supports the SDT, an indication of whether the SDT was performed on a normal uplink (NUL) or a supplementary uplink (SUL), an indication of whether the UE has switched to a connected mode after the SDT, an indication of whether the UE has switched to an inactive mode after the SDT, an indication of whether the UE has received an RRC reject message after the SDT, or an indication of whether the SDT has failed.

18. The base station of claim 16, wherein the at least one processor is further configured to:
transmit, to the UE, a UE information request message for the RA report in a RRC connected state; and
based on the UE information request message, receive, from the UE, a UE information response message including the RA report, and
wherein the RA report includes the SDT information.

19. The base station of claim 16, wherein the at least one processor is further configured to:
transmit, to the UE, system information including second information for the SDT configuration, and
wherein the second information includes at least one of a first threshold value of a reference signal received power (RSRP) or a second threshold value of a data size.

20. The base station of claim 16, wherein the a least one processor is further configured to:
receive, from the UE, UE capability information including at least one of first indication of whether the UE supports the RA report, or a second indication of whether the UE supports the SDT.
